(19) United States
(12) Patent Application Publication
(10) Pub. No.: US 2005/0136325 A1
(43) Pub. Date: Jun. 23, 2005

(54) Sealed prismatic battery

(75) Inventors: Yoshihisa Fujihara, Osaka (JP); Yoshiki Somatomo, Osaka (JP); Mayumi Yamamoto, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 10/995,165

(22) Filed: Nov. 24, 2004

(30) Foreign Application Priority Data
Nov. 27, 2003 (JP) P2003-397719

(51) Int. Cl. H01M 2/02; H01M 2/08

(52) U.S. Cl. 429/176; 429/185

(57) ABSTRACT

A sealed prismatic battery in which the number of manufacturing steps of the battery is not increased and a battery case does not need to be thinned so much for preventing an explosion. The battery includes a prismatic shaped battery case. The battery case has a pair of opposing wide side walls and a pair of opposing narrow side walls and the width between the pair of opposing wide side walls is smaller than a vertical height of the battery case. The thickness of one of the pair of opposing wide side walls is smaller than the thickness of the other.

### BACKGROUND OF THE INVENTION

1. Field of the Invention

The present invention relates to sealed prismatic battery such as a lithium ion secondary battery.

2. Description of the Background Art

Japanese Laid-Open Patent Publication No. 11-111244 (paragraph numbers 0018 to 0022, FIG. 4) and Japanese Laid-Open Patent Publication No. 2001-23595 (paragraph numbers 0017 to 0018, FIG. 1) disclose an sealed prismatic battery provided with a safety valve in which when battery internal pressure is abnormally increased because of a gas generated by overcharging and the like, a thin part formed at a casing of a battery case or a lid is broken to discharge the gas from the battery.

According to the Japanese Laid-Open Patent Publication No. 11-111244 and Japanese Laid-Open Patent Publication No. 2001-23595, since the thin part is formed by a pressing or cutting work after the casing and the lid are formed, the number of manufacturing steps is increased and manufacturing efficiency of the battery is lowered. In addition, in order to break the thin part surely when the battery internal pressure is abnormally increased, there is a problem in which manufacturing management for forming the thin part is not easy, because it is necessary to form the thin part so that its thickness is considerably small such as about 0.1 mm as shown in a paragraph number [0011] in Japanese Laid-Open Patent Publication No. 11-111244.

### SUMMARY OF THE INVENTION

Thus, it is an object of the present invention to provide a sealed prismatic battery in which the number of manufacturing steps of the battery is not increased and a battery case does not need to be thinned so much for preventing an explosion.

According to an aspect of the present invention, there is provided a sealed prismatic battery including a prismatic shaped battery case, the battery case having a pair of opposing wide side walls and a pair of opposing narrow side walls and the width between the pair of opposing wide side walls being smaller than a vertical height of the battery case, the thickness of one of the pair of opposing wide side walls being smaller than the thickness of the other.

Preferably the thickness of one of the pair of opposing wide side walls is smaller than the thickness of the other by 0.05 to 0.1 mm.

According to another aspect of the present invention, there is provided a sealed prismatic battery including a prismatic shaped battery case, the battery case including a battery casing having a cylindrical shape of body with a bottom wall and an upper opening, and a lid which fits in the upper opening of the battery casing, the outer periphery of the lid being welded to the periphery of the upper opening, and the battery casing having a pair of opposing wide side walls and a pair of opposing narrow side walls and the width between the pair of opposing wide side walls being smaller than a vertical height of the battery case, the thickness of one of the pair of opposing wide side walls being smaller than the thickness of the other.

Preferably the thickness of one of the pair of opposing wide side walls of the battery casing is smaller than the thickness of the pair of opposing narrow side walls and a bottom wall of the battery casing and the lid.

It is also preferable that the thickness of one of the pair of opposing wide side walls of the battery casing is set within a range 0.15 to 0.4 mm and smaller than the thickness of the other side wall by 0.05 to 0.1 mm.

### BRIEF DESCRIPTION OF THE DRAWINGS

These and other objects and features of the present invention will become clear from the following description taken in conjunction with the preferred embodiments thereof and the accompanying drawings throughout which like parts are designated by like reference numerals, and in which:

FIG. 1 is a partially notched front view of a sealed prismatic battery of an example according to the present invention;

FIG. 2 is a sectional view taken along A-A in FIG. 1;

FIG. 3 is a perspective view showing a state in which a battery is swollen abnormally; and

FIG. 4 is a longitudinal sectional side view showing a casing of another example according to the present invention.

### DETAILED DESCRIPTION OF THE PREFERRED EMBODIMENTS

This application is based on application No. 2003-397719 filed Nov. 27, 2003 in Japan, the content of which is incorporated hereinto by reference.

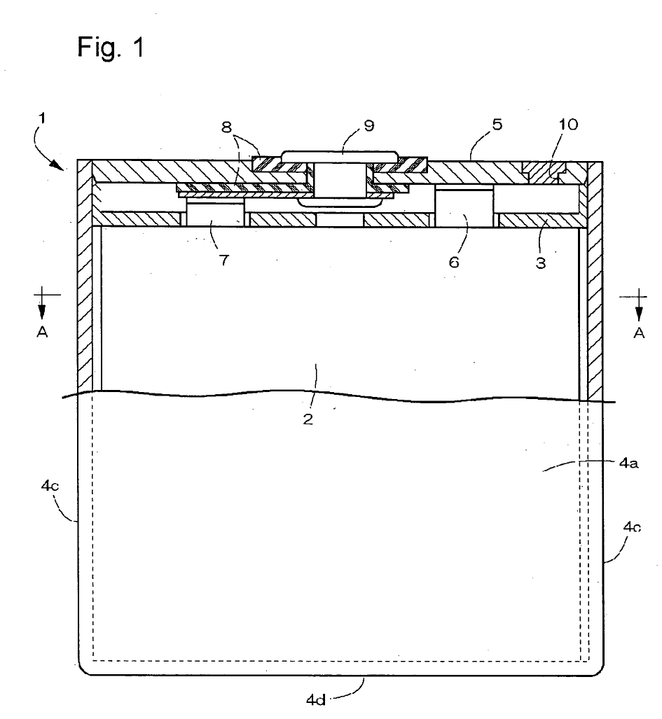

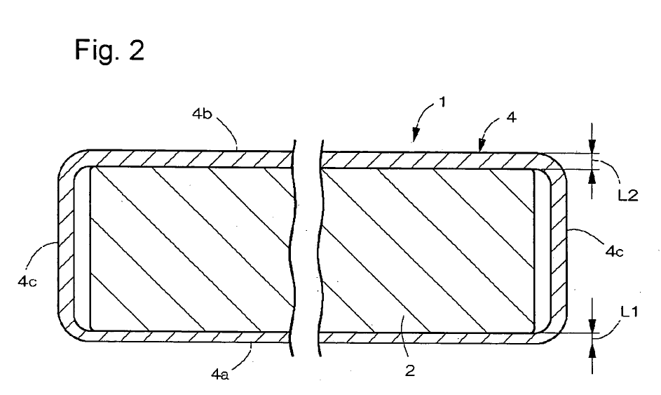

Referring to FIGS. 1 and 2, one embodiment of the present invention is described hereinafter. A prismatic battery case 1 in which a thickness is smaller than a vertical height and width is provided and a thickness L1 of a front side wall 4a is smaller than a thickness L2 of a rear side wall 4b in the front and the rear side walls 4a and 4b having a larger area among the front and the rear side walls 4a and 4b and right and left side walls 4c of the battery case 1. Here, the thickness L1 of the entire front side wall 4a may be smaller than the thickness L2 of the rear side wall 4b or the thickness L1 of a part of the front side wall 4a such as an upper half or a right half may be smaller than the thickness L2 of the rear side wall 4b.

More specifically, the thickness of the front side wall 4a of the battery case 1 is smaller than the thickness of the rear side wall 4b by 0.05 to 0.1 mm. If the difference in thickness between the front side wall 4a and the rear side wall 4b is less than 0.05 mm, when the battery internal pressure is abnormally increased, since a difference in expansion between the front side wall 4a and the rear side wall 4b is too small, the rear side wall 4b may be broken before the front side wall 4a. If the difference in thickness between the front side wall 4a and the rear end 4b is more than 0.10 mm, the front side wall 4a becomes too thin and it is difficult to press the casing 4 or the rear side wall 4b becomes too thick and weight of the casing 4 is increased.

In addition, according to the present invention, a prismatic battery case 1 in which a thickness is smaller than a vertical height and a width is provided and it is characterized in that the battery case 1 includes a prismatic cylindrical casing 4 having a bottom part and an upper opening, and a laterally long lid 5 which fist in the upper opening of the battery casing 4, a thickness L1 of a front side wall 4a is smaller than a thickness L2 of a rear side wall 4b in the front and the rear side walls 4a and 4b having a larger area among the front and the rear side walls 4a and 4b and right and left side walls 4c of the battery casing 4, and an outer periphery of the lid 5 is hermetically weld to the open upper periphery of the casing 4.

The thickness L1 of the entire front side wall 4a of the casing 4 is smaller than thickness of the right and left side walls 4c and the bottom wall 4d of the casing 4 and the lid 5.

The thickness of the front side wall 4a of the casing 4 is set within a range 0.15 to 0.4 mm and smaller than the thickness of the rear side wall 4b by 0.05 to 0.1 mm. If the thickness of the front side wall 4a of the casing 4 is less than 0.15 mm, the front side wall 4a becomes too thin, it is difficult to weld the lid 5 to the upper end of the front side wall 4a which is the open upper periphery of the casing 4, and if the thickness of the front side wall 4a is more than 0.4 mm, it is not preferable from a viewpoint of weight reduction of the casing 4.

Although FIGS. 1 and 2 show an example of the battery case in which a pair of opposing wide side walls and a pair of opposing narrow side walls are the front and rear side walls and the left and right side walls, respectively, it is possible to employ a pair of opposing wide side walls and a pair of opposing narrow side walls as the left and right side walls and the front and rear side walls, respectively.

According to the sealed prismatic battery of the present invention, when the battery internal pressure is abnormally increased, the front and the rear side walls 4a and 4b having a larger area in the battery case 1 is swollen outward in the front and rear direction and thinned, and the front side wall 4a becomes thin faster than the rear side wall 4b because it is originally thinner. When the battery case 1 is expanded to a limiting point to be deformed, the front side wall 4a is broken before the rear side wall 4b, so that gas in the battery is released from the broken parts to prevent an explosion of the battery. Since the front side wall 4a is expanded outwardly, thinned and broken, the front side wall 4a does not need to be decreased in thickness as thin as the thickness of the conventional thin part. As a result, the manufacturing management of the battery case 1 becomes easy and the front side wall 4a can be prevented from being decreased in strength.

In order to form the thickness of the front side wall 4a thinner than the rear side wall 4b, since a clearance between punch and die is only adjusted when the battery case 1 is formed, it is not necessary to perform the pressing or cutting work for preventing an explosion after the battery case 1 is formed. As a result, the manufacturing efficiency of the battery can be improved. Furthermore, since the place from which the gas is discharged can be specified to the front side wall 4a, a discharge path of the gas may only be provided at a part opposed to the front side wall 4a in an apparatus which uses the battery of the present invention. As a result, the apparatus can be easily designed.

As described above, since the front side wall 4a does not need to be decreased in thickness as thin as the thickness of the conventional thin part, the outer periphery of the lid 5 of the battery case 1 can be surely welded to the open upper periphery of the casing 4 in an airtight state.

### EXAMPLE 1

FIGS. 1 and 2 show a first example of a sealed prismatic battery according to the present invention. An electrode body 2 and a non-aqueous electrolyte are hermetically housed in a laterally long and prismatic-shaped thin type of battery case 1 in which a thickness is smaller than a vertical height and a width, and an insulator 3 made of plastic is positioned at an upper end in the battery case 1. More specifically, the width is 34 mm, the thickness is 5 mm, and the vertical height is 45 mm in the battery case 1.

The battery case 1 includes a prismatic tubular casing 4 having a bottom part and an upper opening, and a laterally long lid 5 which fits in the upper opening of the casing 4 hermetically. The casing 4 is formed by deep-draw processing an aluminum plate. Four corners at front and rear sides and right and left sides of the battery case 1 are circularly formed as shown in FIG. 1.

According to the electrode body 2, a positive electrode and negative electrode are spirally wound around with a separator provided between them and the whole is crushed to be deformed into flat prismatic on cross section so as to coincide with a sectional configuration of the battery case 1. As shown in FIG. 2, a positive and a negative collector leads 6 and 7 extend upwardly from the positive and negative electrodes of the electrode body 2, respectively.

The lid 5 is a press molded part containing an aluminum alloy plate, and its outer periphery is hermetically sealed and welded to an upper opening periphery of the casing 4 with a laser. A negative terminal 9 is mounted at the center of the lid 5 so as to penetrate it through an insulating packing 8. A thickness of the lid 5 is 0.8 mm.

An injection hole 10 is provided at a lateral end of the lid 5 and the electrolyte is injected into the battery case 1 through the injection hole 10. The injection hole 10 is sealed after the electrolyte is injected. The negative collector lead 7 is welded to a lower end of the negative terminal 9. The positive collector lead 6 is welded to an inner face of the lid 5 between the insulating packing 8 and the injection hole 10. Thus, the positive collector lead 6 is conducted to the battery case 1 and the battery case 1 serves as a positive electrode terminal.

According to the casing 4, a thickness L1 of a front side wall 4a is smaller than a thickness L2 of a rear side wall 4b. That is, the thickness L1 of the front side wall 4a is 0.2 mm and the thickness L2 of the rear side wall 4b is 0.3 mm. A thickness of each of right and left side walls 4c of the casing 4 is 0.3 mm.

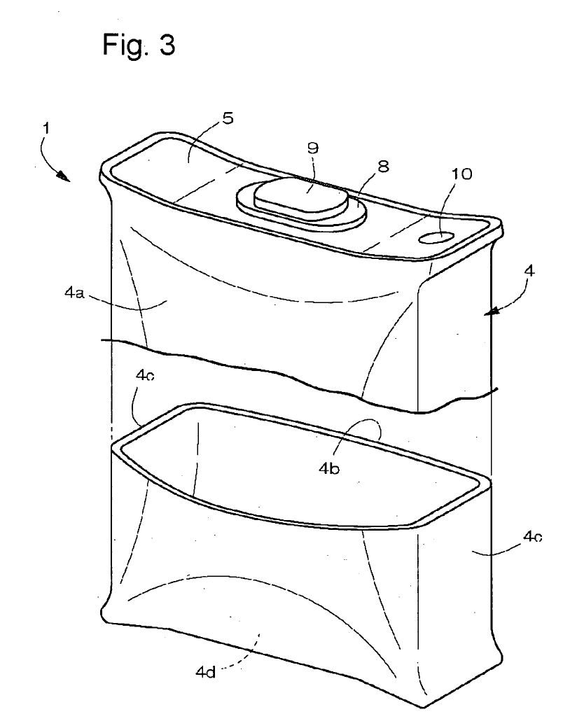

When a battery internal pressure is abnormally increased beyond a predetermined value, as shown in FIG. 3, the battery case 1 is swollen and deformed. That is, the front and the rear side walls 4a and 4b having a larger area of the casing 4 are swollen outward in the front and rear direction. Accordingly, the right and the left side walls 4c, 4c and a bottom wall 4d of the casing 4 and the lid 5 are deformed to be curved at the center.

As the battery internal pressure is further increased, the front and the rear side walls 4a and 4b of the casing 4 are further swollen and gradually thinned while the right and left side walls 4c, 4c and the bottom wall 4d and the lid 5 are largely bent near the end of the length direction. The front side wall 4a is thinned faster than the rear side wall 4b because it is thinner.

When the battery case 1 is expanded and deformed to a limiting point, the front side wall 4a is broken from bending points of the right and left side walls 4c, 4c, the bottom wall 4d and the lid 5 before the rear side wall 4b. Thus, gas in the battery is released from the broken parts, so that an explosion of the battery is prevented.

Thus, when the battery internal pressure is increased abnormally, since the front side wall 4a of the battery case 1 is broken first of all and the gas in the battery is discharged, the rear side wall 4b, the right and left side walls 4c, 4c, the bottom wall 4d and the lid 5 are not broken by the battery internal pressure.

### EXAMPLE 2

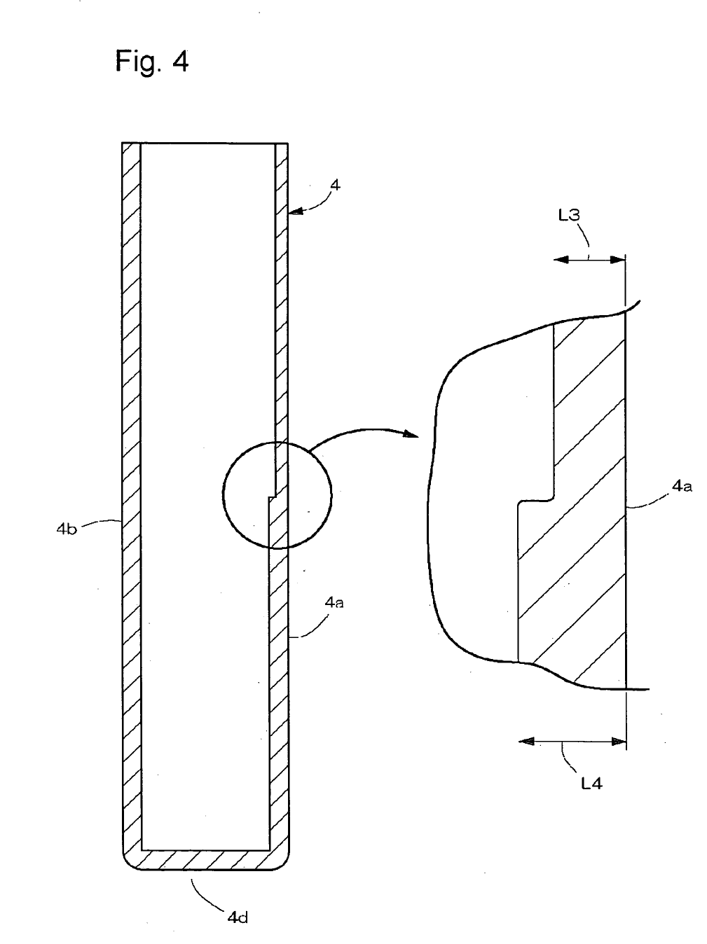

FIG. 4 shows a second example of a sealed prismatic battery according to the present invention, in which a thickness L3 of an upper half of a front side wall 4a of a casing 4 is 0.2 mm, a thickness L4 of a lower half of the front side wall 4a is 0.3 mm. Since others are the same as in the first example, their descriptions are omitted.

According to the second example, although the thickness of the upper half and the lower half of the front side wall 4a are changed so as to have a stepped portion, they may be gradually changed. A thickness of a right half of the front side wall 4a of the casing 4 may be 0.2 mm and a thickness of a left half of the front side wall 4a may be 0.3 mm.

Although the present invention is suitable for the sealed prismatic battery in which a width is 30 to 34 mm, a thickness is 3 to 6 mm and a vertical height is 20 to 50 mm in the battery case 1, these dimensions may be arbitrarily changed.

Although the present invention has been described in connection with the preferred examples thereof with reference to the accompanying drawings, it is to be noted that various changes and modifications are apparent to those skilled in the art. Such changes and modifications are to be understood as included within the scope of the present invention as defined by the appended claims, unless they depart therefrom.

1. A sealed prismatic battery comprising a prismatic shaped battery case, the battery case having a pair of opposing wide side walls and a pair of opposing narrow side walls and the width between the pair of opposing wide side walls being smaller than a vertical height of the battery case, the thickness of one of the pair of opposing wide side walls being smaller than the thickness of the other.

2. The sealed prismatic battery according to claim 1, wherein the thickness of one of the pair of opposing wide side walls is smaller than the thickness of the other by 0.05 to 0.1 mm.

3. A sealed prismatic battery comprising a prismatic shaped battery case, the battery case comprising a battery casing having a cylindrical shape of body with a bottom wall and an upper opening, and a lid which fits in the upper opening of the battery casing, the outer periphery of the lid being welded to the periphery of the upper opening, and the battery casing having a pair of opposing wide side walls and a pair of opposing narrow side walls and the width between the pair of opposing wide side walls being smaller than a vertical height of the battery case, the thickness of one of the pair of opposing wide side walls being smaller than the thickness of the other.

4. The sealed prismatic battery according to claim 3, wherein the thickness of one of the pair of opposing wide side walls of the battery casing is smaller than the thickness of the pair of opposing narrow side walls and a bottom wall of the battery casing and the lid.

5. The sealed prismatic battery according to claim 3, wherein the thickness of one of the pair of opposing wide side walls of the battery casing is set within a range 0.15 to 0.4 mm and smaller than the thickness of the other by 0.05 to 0.1 mm.
